(19) United States
(12) Patent Application Publication
(10) Pub. No.: US 2025/0276205 A1
(43) Pub. Date: Sep. 4, 2025

(54) FIRE EXTINGUISHING AGENT SPRAY DEVICE

(71) Applicant: Samsung SDI Co., Ltd., Yongin-si (KR)

(72) Inventors: Dong Seok IN, Yongin-si (KR); In Hyeok SONG, Yongin-si (KR)

(21) Appl. No.: 18/819,577

(22) Filed: Aug. 29, 2024

(30) Foreign Application Priority Data
Mar. 4, 2024 (KR) 10-2024-0030418

(51) Int. Cl. A62C 35/02; A62C 3/16

(52) U.S. Cl. CPC A62C 35/023; A62C 3/16

(57) ABSTRACT

Disclosed is a fire-extinguishing agent spray device including a spray container for storing a fire-extinguishing agent, and including an inwardly convex container bottom surface, and a siphon tube in the spray container, and including a lower end adjacent to the container bottom surface and having an inclination angle with respect to a reference line based on a center of an inner surface of the container bottom surface.

### CROSS-REFERENCE TO THE RELATED APPLICATION

The present application claims priority to and the benefit of Korean Patent Application No. 10-2024-0030418, filed on Mar. 4, 2024, in the Korean Intellectual Property Office, the entire disclosure of which is incorporated herein by reference.

### BACKGROUND

### 1. Field

Embodiments of the present disclosure relate to a fire-extinguishing agent spray device capable of reducing or minimizing the remaining amount of fire-extinguishing agent.

### 2. Description of the Related Art

Conventional energy storage systems (ESSs) employ a total flooding gaseous fire-extinguishing system that releases a fire-extinguishing agent into a sealed space in the event of a fire. As batteries have increased in capacity, the total flooding gaseous fire-extinguishing system may not achieve suitable fire-extinguishing effects in the event of a fire. To solve this problem, it may be desirable to develop a fire-extinguishing system that is suitable for high-capacity energy storage systems.

The information disclosed in this section is provided only for enhancement of understanding of the background of the disclosure, and therefore may contain information that does not form the related art.

### SUMMARY

Embodiments of the present disclosure provide a fire-extinguishing agent spray device capable of reducing or minimizing the remaining amount of fire-extinguishing agent.

A fire-extinguishing agent spray device according to one or more embodiments of the present disclosure includes a spray container for storing a fire-extinguishing agent, and including an inwardly convex container bottom surface, and a siphon tube in the spray container, and including a lower end adjacent to the container bottom surface and having an inclination angle with respect to a reference line based on a center of an inner surface of the container bottom surface.

The fire-extinguishing agent spray device may further include a discharge valve coupled to an upper end of the spray container.

The siphon tube may include an upper end connected to the discharge valve.

The siphon tube may include a hollow tube.

The reference line may be based on an inner top point of the container bottom surface.

The reference line may be a horizontal line passing through the inner top point of the container bottom surface.

The inclination angle of the lower end of the siphon tube may be about 0 degrees or more.

A distance (h) from the lower end of the siphon tube to the inner top point of the container bottom surface may be calculated as follows

$$h = \frac{π {r}_{t}^{2}}{2 π {r}_{t}} + p$$

wherein rₜ represents an inner radius of the siphon tube, and wherein ρ represents a pitch of a thread for assembling the siphon tube to the discharge valve.

The inclination angle of the lower end of the siphon tube may be equal to or less than an inclination angle of the container bottom surface.

The inclination angle of the lower end of the siphon tube may be about 10 degrees or less.

A distance (h) from the lower end of the siphon tube to an inner top point of the container bottom surface may be calculated as follows

$$h = \frac{π {r}_{t}^{2} - ( 2 π {r}_{t}^{2} \times tan θ )}{2 π {r}_{t}} + p$$

wherein rₜ represents an inner radius of the siphon tube, wherein ρ represents a pitch of a thread for assembling the siphon tube to the discharge valve, and wherein θ represents the inclination angle of the lower end of the siphon tube with respect to the reference line based on the center of the inner surface of the container bottom surface.

A fire-extinguishing agent spray device according to one or more other embodiments of the present disclosure includes a spray container for storing a fire-extinguishing agent and including an outwardly convex container bottom surface, and a siphon tube in the spray container, and including a lower end adjacent to the container bottom surface and having an inclination angle with respect to a reference line based on a center of an inner surface of the container bottom surface.

The fire-extinguishing agent spray device may further include a discharge valve coupled to an upper end of the spray container.

The siphon tube may include an upper end connected to the discharge valve.

The siphon tube may include a hollow tube.

The reference line may be based on an inner bottom point of the container bottom surface.

The reference line may be a horizontal line passing through the inner bottom point of the container bottom surface.

The inclination angle of the lower end of the siphon tube may be about 0 degrees or more.

A distance (h) from the lower end of the siphon tube to the inner bottom point of the container bottom surface may be calculated as follows

$$h = \frac{π {r}_{t}^{2}}{2 π {r}_{t}} + p$$

wherein rₜ represents an inner radius of the siphon tube, and wherein ρ represents a pitch of a thread for assembling the siphon tube to the discharge valve.

The distance from the lower end of the siphon tube to the inner bottom point of the container bottom surface may be about three times the pitch of the thread.

The fire-extinguishing agent spray device may further include a support part for supporting a lower end of the spray container.

### BRIEF DESCRIPTION OF THE DRAWINGS

FIG. 1 is a schematic diagram showing a fire-extinguishing agent spray device for energy storage systems;

FIG. 2 is a view schematically showing a self-supporting spray container according to one or more embodiments of the present disclosure;

FIGS. 3 and 4 are views showing forms of a siphon tube shown in FIG. 2;

FIG. 5 is a view schematically showing a support-structure-attached spray container according to one or more other embodiments of the present disclosure;

FIGS. 6 and 7 are views showing forms of a siphon tube shown in FIG. 5;

FIG. 8 is a view showing a comparison between the self-supporting spray container shown in FIG. 2 and a conventional self-supporting spray container; and

FIG. 9 is a view showing a comparison between the support-structure-attached spray container shown in FIG. 5 and a conventional support-structure-attached spray container.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that the present disclosure covers all modifications, equivalents, and replacements within the idea and technical scope of the present disclosure, that each of the features of embodiments of the present disclosure may be combined with each other, in part or in whole, and technically various interlocking and operating are possible, and that each embodiment may be implemented independently of each other, or may be implemented together in an association, unless otherwise stated or implied.

In the drawings, the relative sizes of elements, layers, and regions may be exaggerated for clarity and/or descriptive purposes. Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the term “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Hereinafter, a fire-extinguishing agent spray device according to one or more embodiments of the present disclosure will be described with reference to the accompanying drawings.

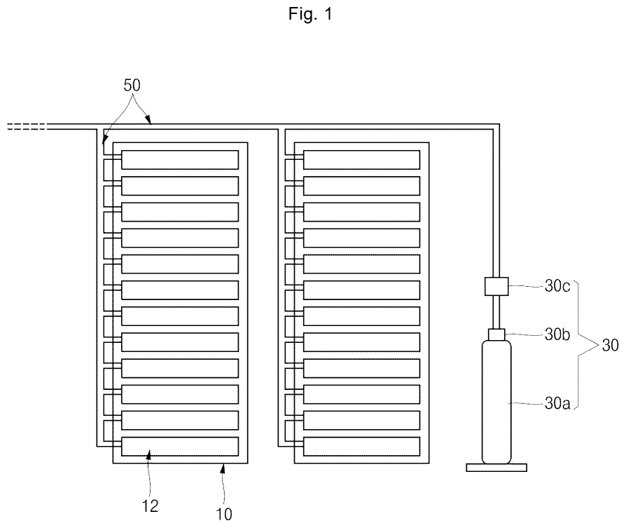

FIG. 1 is a schematic diagram showing a fire-extinguishing agent spray device for energy storage systems.

As shown in FIG. 1, a fire-extinguishing agent spray device for energy storage systems may broadly include a supply part 30 configured to supply a fire-extinguishing agent to an energy storage system (ESS) 10, a fire-extinguishing part 50 configured to convey and spray the fire-extinguishing agent, and a sensor configured to detect a fire.

In one or more embodiments, the supply part 30 may include a spray container 30a configured to store the fire-extinguishing agent, a discharge valve 30b for spraying the fire-extinguishing agent, a regulator 30c configured to regulate supply pressure and time of the fire-extinguishing agent, and a controller for control of the device.

The spray container 30a may be a pressure container storing the fire-extinguishing agent. The spray container 30a may be classified into a self-supporting type and a support-structure-attached type depending on whether the same is capable of being installed independently. For example, the fire-extinguishing agent may include carbon dioxide, halon, a halogen compound, an inert gas, or the like. Nitrogen may be used as a compressed gas for spray of the fire-extinguishing agent.

If the controller determines to spray the fire-extinguishing agent, the discharge valve 30b may be opened so that the fire-extinguishing agent is sprayed. The discharge valve 30b may serve to open or close the spray container 30a, and may be connected to a siphon tube to be described later. If the discharge valve 30b is opened, the fire-extinguishing agent may be discharged and moved to the regulator 30c. The regulator 30c may serve to regulate the spray pressure of the fire-extinguishing agent to a final spray pressure. To this end, the regulator 30c may be implemented as a pressure regulator.

The fire-extinguishing part 50 may include a main pipe, a branch pipe, and a spray pipe, which extend from the supply part 30 to each of a plurality of battery modules 12 of the ESS 10. The plurality of battery modules 12 may be mounted on a plurality of battery racks, and the branch pipe and the spray pipe for spray of the fire-extinguishing agent may be mounted to each of the battery racks. The fire-extinguishing part 50 may serve to connect the supply part 30 to the ESS 10.

In one or more embodiments, if a fire occurs in the battery modules 12, the sensor may detect the occurrence of a fire, and the fire-extinguishing agent may be discharged from the supply part 30 to be conveyed to the battery modules 12 through the fire-extinguishing part 50. Thus, the fire-extinguishing agent may be rapidly sprayed to the battery modules 12, thereby extinguishing the fire occurring in the battery modules 12.

Hereinafter, the spray container of the fire-extinguishing agent spray device described above will be described in detail.

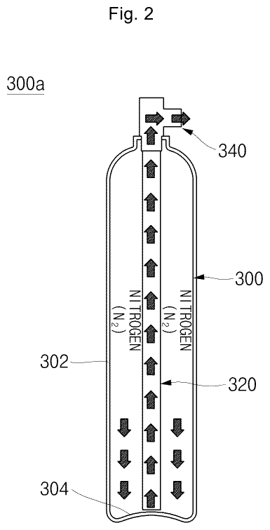

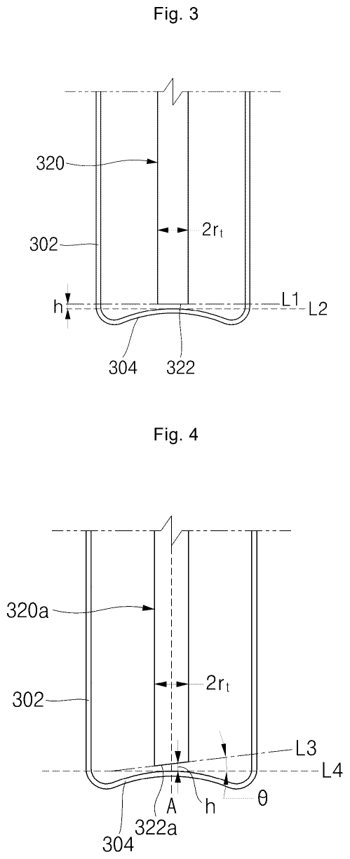

FIG. 2 is a view schematically showing a self-supporting spray container according to one or more embodiments of the present disclosure. FIGS. 3 and 4 are views showing forms of a siphon tube shown in FIG. 2.

As shown in FIG. 2, a self-supporting spray container 300a may be a container that is capable of being installed independently without a separate structure for supporting the container. The self-supporting spray container 300a may include a cylinder 300, a siphon tube 320 inserted into the cylinder 300, and a discharge valve 340 for discharge of a fire-extinguishing agent. The discharge valve 340 may be coupled to the upper end of the cylinder 300.

The cylinder 300 may include a container side surface 302 having a cylindrical shape, and a container bottom surface 304 formed to be convex toward the discharge valve 340. The container side surface 302 and the container bottom surface 304 may be integrally formed with each other. The cylinder 300 may be filled with a fire-extinguishing agent and nitrogen. Nitrogen may be contained as a compressed gas in the cylinder 300 in a state of pressurizing the fire-extinguishing agent. If the discharge valve 340 is opened, the compressed nitrogen gas may expand and push the fire-extinguishing agent out. The fire-extinguishing agent may move upwardly along the siphon tube 320, and may be discharged out of the cylinder 300 through the discharge valve 340.

One end of the siphon tube 320 may be fixed to the discharge valve 340, and the other end thereof may be located adjacent to the container bottom surface 304. The siphon tube 320 may be formed as a hollow tube or a hollow pipe. As shown in FIG. 3, the siphon tube 320 may have an end (e.g., lower end) 322 that faces the container bottom surface 304, and that is substantially perpendicular to the side surface of the siphon tube 320. For example, a reference line L1 passing through the end 322 of the siphon tube 320 may be substantially parallel to a reference line L2 passing through, or tangential to, an inner top point of the container bottom surface 304. A distance h from the end 322 of the siphon tube 320 to the inner top point of the container bottom surface 304 (e.g., a distance between the reference lines L1 and L2) may be calculated using Equation 1 below.

$$h = \frac{π {r}_{t}^{2}}{2 π {r}_{t}} + p \qquad Equation 1$$

The variable rₜ represents the inner radius (e.g., in mm) of the siphon tube, and p represents the pitch (e.g., in mm) of a thread (e.g., a distance between threads) that is used to assemble the siphon tube to the discharge valve. The pitch of a thread may vary depending on the specifications and size of a screw.

In other embodiments, and referring to FIG. 4, the siphon tube 320a may have an end 322a that faces the container bottom surface 304, and that is beveled at a relatively small inclination angle θ with respect to a plane that is substantially perpendicular to the side surface of the siphon tube 320a. For example, a distance h from the center of the end 322a of the siphon tube 320a (the center of the end through which a reference line A passes) to the inner top point of the container bottom surface 304 may be identical to the distance h in the one or more embodiments corresponding to FIG. 3, and the inclination angle θ (e.g., an angle formed between reference lines L3 and L4) may be identical to an angle at which the container bottom surface 304 is inclined. The distance h from the center of the end 322a of the siphon tube 320a to the inner top point (indicated by L4) of the container bottom surface 304 may be calculated using Equation 2 below.

$$h = \frac{π {r}_{t}^{2} - ( 2 π {r}_{t}^{2} \times tan θ )}{2 π {r}_{t}} + p \qquad Equation 2$$

The variable rₜ represents the inner radius (e.g., in mm) of the siphon tube, ρ represents the pitch (e.g., in mm) of the thread (e.g., a distance between the threads), and θ represents the inclination angle of the end of the siphon tube with respect to the reference line L4 passing through the inner top point of the container bottom surface (e.g., an angle formed between reference lines L3 and L4).

The remaining amount Ra (e.g., in kg) of fire-extinguishing agent may vary depending on the inclination angle of the end 322a of the siphon tube 320a. The remaining amount Ra of fire-extinguishing agent may be calculated using Equation 3 below.

$$Ra = π {r}_{t}^{2} \times 2 {r}_{t} \times sin θ \times {d}_{r} \qquad Equation 3$$

The variable r_{c} represents the inner radius (e.g., in mm) of the spray container, rₜ represents the inner radius (e.g., in mm) of the siphon tube, dr represents the relative density of the fire-extinguishing agent (relative density of water is 1), and 0 represents the inclination angle of the end of the siphon tube with respect to the reference line L4 passing through the inner top point of the container bottom surface.

For example, under the condition that the inner diameter of the spray container 300a is about 260 mm and the inner diameter of the siphon tube 320a is about 40 mm, the remaining amount Ra of the fire-extinguishing agent according to the inclination angle of the end 322a of the siphon tube 320a is shown in Table 1 below.

TABLE 1

| Inclination | Cross- | | Height of | | Relative | |
|---|---|---|---|---|---|---|
| Angle of | Sectional | | Opening | | Density | Weight |
| End of | Area of | Diameter | from Distal | Vol- | of Agent | of |
| Tube | Cylinder | of Tube | End of | ume | (Water = | Agent |
| [°] | [m²] | [m] | Tube [m] | [L] | 1) | [kg] |
| 45 | 0.053 | 0.04 | 0.028 | 1.502 | 1.6 | 2.403 |
| 40 | 0.053 | 0.04 | 0.026 | 1.365 | 1.6 | 2.184 |
| 35 | 0.053 | 0.04 | 0.023 | 1.218 | 1.6 | 1.949 |
| 30 | 0.053 | 0.04 | 0.020 | 1.062 | 1.6 | 1.699 |
| 25 | 0.053 | 0.04 | 0.017 | 0.898 | 1.6 | 1.436 |
| 20 | 0.053 | 0.04 | 0.014 | 0.726 | 1.6 | 1.162 |
| 15 | 0.053 | 0.04 | 0.010 | 0.550 | 1.6 | 0.879 |
| 10 | 0.053 | 0.04 | 0.007 | 0.369 | 1.6 | 0.590 |
| 5 | 0.053 | 0.04 | 0.003 | 0.185 | 1.6 | 0.296 |

If considering only the remaining amount of fire-extinguishing agent, then the smaller the inclination angle θ of the end 322a of the siphon tube 320a, the better. Considering both processability of the end 322a of the siphon tube 320a and the remaining amount of fire-extinguishing agent, the optimal or suitable value of the inclination angle θ of the end 322a of the siphon tube 320a with respect to the reference line L4 passing through the inner top point of the container bottom surface 304 of the spray container 300a may be a maximum of about 10 degrees.

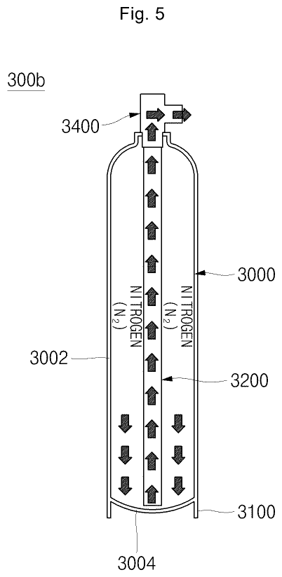

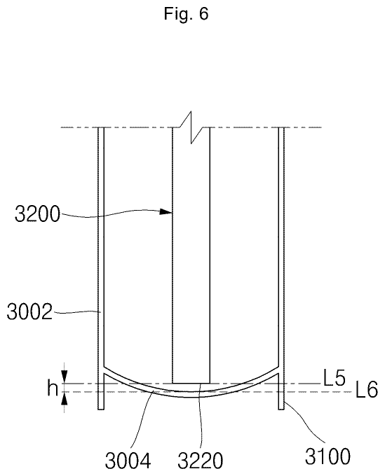

FIG. 5 is a view schematically showing a support-structure-attached spray container according to one or more other embodiments of the present disclosure. FIGS. 6 and 7 are views showing forms of a siphon tube shown in FIG. 5.

As shown in FIG. 5, a support-structure-attached spray container 300b may be a container that is coupled to a separate structure for supporting the container. The support-structure-attached spray container 300b may include a cylinder 3000, a siphon tube 3200 inserted into the cylinder 3000, and a discharge valve 3400 for discharge of a fire-extinguishing agent. The lower end of the cylinder 3000 may be supported by a support part 3100. The support part 3100 may be integrally formed with the cylinder 3000 or may be separately provided and assembled to the cylinder 3000.

The cylinder 3000 may include a container side surface 3002 having a cylindrical shape, and a container bottom surface 3004 formed to be convex in a direction away from the discharge valve 3400. The container side surface 3002 and the container bottom surface 3004 may be integrally formed with each other. Because the container bottom surface 3004 is formed to be convex in an outward direction, the cylinder 3000 may be suitably coupled to a separate support structure. The cylinder 3000 may be supported by the cylindrical support part 3100 supporting the lower end of the cylinder 3000. The cylinder 3000 may be filled with a fire-extinguishing agent and nitrogen. Nitrogen may be contained as a compressed gas in the cylinder 3000 in a state of pressurizing the fire-extinguishing agent. If the discharge valve 3400 is opened, the compressed nitrogen gas may expand and push the fire-extinguishing agent out. The fire-extinguishing agent may move upwardly along the siphon tube 3200, and may be discharged out of the cylinder 3000 through the discharge valve 3400.

One end of the siphon tube 3200 may be fixed to the discharge valve 3400, and the other end thereof may be located adjacent to the container bottom surface 3004. The siphon tube 3200 may be formed in the shape of a hollow cylinder. As shown in FIG. 6, the siphon tube 3200 may have an end (e.g., lower end) 3220 that faces the container bottom surface 3004, and that is substantially perpendicular to the side surface of the siphon tube 3200. For example, a reference line L5 passing through the end 3220 of the siphon tube 3200 may be parallel to a reference line L6 passing through an inner bottom point of the container bottom surface 3004. A distance h from the end 3220 of the siphon tube 3200 to the inner bottom point of the container bottom surface 3004 (e.g., a distance between the reference lines L5 and L6) may be calculated using Equation 1 above.

In other embodiments, and referring to FIG. 7, the siphon tube 3200a may have an end 3220a that faces the container bottom surface 3004, and that is beveled at a relatively small inclination angle θ with respect to a plane that is substantially perpendicular to the side surface of the siphon tube 3200a. For example, a distance h from the center of the end 3220a of the siphon tube 3200a (the center of the end through which a reference line B passes) to the inner bottom point of the container bottom surface 3004 may be identical to the distance h in the one or more embodiments corresponding to FIG. 6, and the inclination angle θ (e.g., an angle formed between reference lines L6 and L7) may be set such that the distance h from the end 3220a of the siphon tube 3200a to the inner bottom point of the container bottom surface 3004 is three times the pitch of the thread in Equation 1 above (e.g., h=3p).

Hereinafter, the siphon tubes according to the embodiments of the present disclosure having the above-described structures, and conventional siphon tubes will be compared and contrasted with each other.

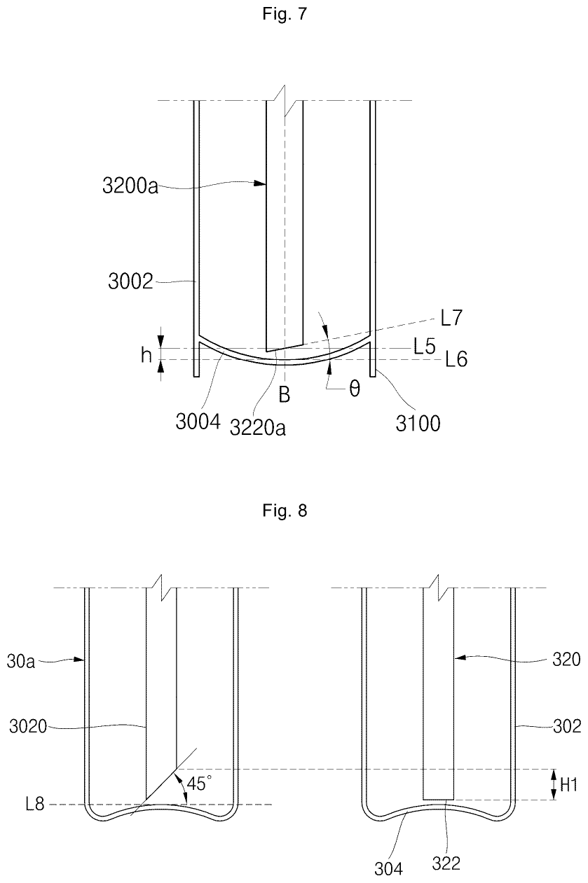

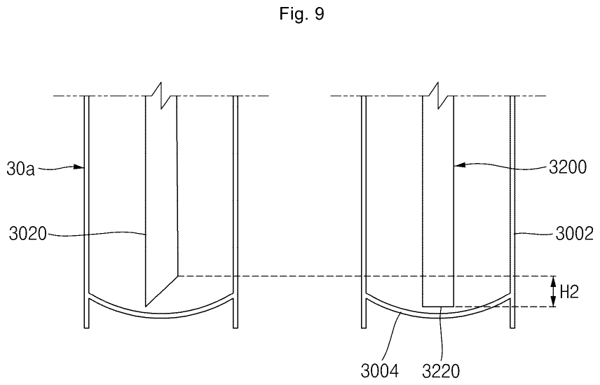

FIG. 8 is a view showing a comparison between the self-supporting spray container shown in FIG. 2 and a conventional self-supporting spray container. FIG. 9 is a view showing a comparison between the support-structure-attached spray container shown in FIG. 5 and the conventional support-structure-attached spray container.

Cylinders as the spray container 30a, which are respectively shown in the left parts of FIGS. 8 and 9, are comparative examples including a conventional siphon tube 3020. The conventional siphon tube 3020 may have an end that is beveled at an inclination angle of about 45 degrees (e.g., an angle formed between the end of the siphon tube 3020 and a reference line L8 passing through the inner top point of the container bottom surface), which is much larger than the inclination angles of the ends of the siphon tubes 320 and 3200 according to the embodiments described above. The reason for this structure is to maximally increase, or to improve, the cross-sectional area of the end of the siphon tube 3020 to completely discharge a fire-extinguishing agent, which is pressurized at a high pressure of several tens of bars, in a short time (within 10 seconds). Because the inclination angle of the end of the conventional siphon tube 3020 is relatively large, it may be possible to secure a sufficient flow path if the discharge valve is opened, thereby discharging the fire-extinguishing agent without clogging of the siphon tube. If the level of remaining fire-extinguishing agent falls below the start point of the opening of the end of the conventional siphon tube 3020 (indicated by the first dotted line in each of FIGS. 8 and 9), a compressed gas may be discharged abruptly. Thus, the power for discharging the remaining fire-extinguishing agent through the siphon tube may be lost, which may entail a problem in which a large amount of fire-extinguishing agent remains on the bottom of the container. Referring to Table 1 above, a fire-extinguishing agent of about 2.4 kg or more may remain in the conventional spray container. This may cause reduction in a fire-extinguishing agent discharge time. Further, to satisfy a suitable discharge amount of fire-extinguishing agent, a larger amount of fire-extinguishing agent, which may be relatively expensive, may be suitably injected into the conventional spray container, leading to increase in device production or maintenance costs.

As shown in the right part of each of FIGS. 8 and 9, the start point of the opening of the end 322 or 3220 of the siphon tube 320 or 3200 according to one or more embodiments of the present disclosure (indicated by the second dotted line in each of FIGS. 8 and 9) may be located at a lower position than that of the conventional siphon tube. In some embodiments, the end 322 or 3220 of the siphon tube 320 or 3200 may be substantially perpendicular to the side surface of the siphon tube 320 or 3200 (refer to FIGS. 3 and 6). In other embodiments (e.g., see FIGS. 4 and 7), the end 322a or 3220a of the siphon tube 320a or 3200a may be beveled at a relatively small inclination angle (e.g., a maximum of about 10 degrees) with respect to a plane that is substantially perpendicular to the side surface of the siphon tube 320a or 3200a. Thus, the start point of the opening of the end of the siphon tube 320, 3200, 320a, or 3200a according to one or more embodiments of the present disclosure is much closer to the bottom surface 304 or 3004 of the spray container than that of the conventional siphon tube. Because the end 322, 3220, 322a, or 3220a of the siphon tube 320, 3200, 320a, or 3200a according to one or more embodiments of the present disclosure is relatively close to the bottom surface 304 or 3004 of the spray container, it may be possible to maximally discharge, or to discharge in an improved manner, the fire-extinguishing agent. Thus, the remaining amount of fire-extinguishing agent may be reduced or minimized (refer to Table 1 above).

A fire-extinguishing device for energy storage systems directly sprays a fire-extinguishing agent only to a battery cell in which an event such as a fire occurs at a very low flow rate, for example, about 4 liters per minute (LPM). Because the fire-extinguishing agent is directly sprayed only to a target cell or module, it is not necessary to completely spray the fire-extinguishing agent in a short time. Therefore, according to one or more embodiments of the present disclosure, the inclination angle of the end of the siphon tube 320, 3200, 320a, or 3200a may be reduced so that the cross-sectional area of the end is reduced as compared to the conventional siphon tube having an end beveled at an angle of about 45 degrees. Thus, the fire-extinguishing agent may be sprayed at a relatively low flow rate for a relatively long time (e.g., an amount of time that is longer than 10 seconds, which may be the spray time in the related art).

As is apparent from the above description, in a fire-extinguishing agent spray device according to one or more embodiments of the present disclosure, the shape of a siphon tube may be improved so as to be suitable for the shape of the bottom of a fire-extinguishing agent container, whereby the amount of fire-extinguishing agent sprayed in the event of a fire may be improved or maximized. Thus, the amount of fire-extinguishing agent remaining in the fire-extinguishing agent container after completion of spray may be reduced or minimized. In this way, because the fire-extinguishing agent is used more efficiently, the fire-extinguishing performance of the fire-extinguishing agent spray device may be improved, and the device production or maintenance costs may be reduced.

The above are only some embodiments for implementing the disclosure, the disclosure is not limited to the above, and it is to be understood by those skilled in the art that various modifications can be made without departing from the gist of the disclosure as claimed in the following claims, with functional equivalents thereof to be included therein.

What is claimed is:

1. A fire-extinguishing agent spray device comprising:
a spray container for storing a fire-extinguishing agent, and comprising an inwardly convex container bottom surface; and
a siphon tube in the spray container, and comprising a lower end adjacent to the container bottom surface and having an inclination angle with respect to a reference line based on a center of an inner surface of the container bottom surface.

2. The fire-extinguishing agent spray device as claimed in claim 1, further comprising a discharge valve coupled to an upper end of the spray container.

3. The fire-extinguishing agent spray device as claimed in claim 2, wherein the siphon tube comprises an upper end connected to the discharge valve.

4. The fire-extinguishing agent spray device as claimed in claim 3, wherein the siphon tube comprises a hollow tube.

5. The fire-extinguishing agent spray device as claimed in claim 4, wherein the reference line is based on an inner top point of the container bottom surface.

6. The fire-extinguishing agent spray device as claimed in claim 5, wherein the reference line is a horizontal line passing through the inner top point of the container bottom surface.

7. The fire-extinguishing agent spray device as claimed in claim 6, wherein the inclination angle of the lower end of the siphon tube is about 0 degrees or more.

8. The fire-extinguishing agent spray device as claimed in claim 7, wherein a distance (h) from the lower end of the siphon tube to the inner top point of the container bottom surface is calculated as follows:
$$h = \frac{π {r}_{t}^{2}}{2 π {r}_{t}} + p$$
wherein rₜ represents an inner radius of the siphon tube, and wherein ρ represents a pitch of a thread for assembling the siphon tube to the discharge valve.

9. The fire-extinguishing agent spray device as claimed in claim 4, wherein the inclination angle of the lower end of the siphon tube is equal to or less than an inclination angle of the container bottom surface.

10. The fire-extinguishing agent spray device as claimed in claim 9, wherein the inclination angle of the lower end of the siphon tube is about 10 degrees or less.

11. The fire-extinguishing agent spray device as claimed in claim 10, wherein a distance (h) from the lower end of the siphon tube to an inner top point of the container bottom surface is calculated as follows:
$$h = \frac{π {r}_{t}^{2} - ( 2 π {r}_{t}^{2} \times tan θ )}{2 π {r}_{t}} + p$$
wherein rₜ represents an inner radius of the siphon tube, wherein p represents a pitch of a thread for assembling the siphon tube to the discharge valve, and wherein θ represents the inclination angle of the lower end of the siphon tube with respect to the reference line based on the center of the inner surface of the container bottom surface.

12. A fire-extinguishing agent spray device comprising:
a spray container for storing a fire-extinguishing agent and comprising an outwardly convex container bottom surface; and
a siphon tube in the spray container, and comprising a lower end adjacent to the container bottom surface and having an inclination angle with respect to a reference line based on a center of an inner surface of the container bottom surface.

13. The fire-extinguishing agent spray device as claimed in claim 12, further comprising a discharge valve coupled to an upper end of the spray container.

14. The fire-extinguishing agent spray device as claimed in claim 13, wherein the siphon tube comprises an upper end connected to the discharge valve.

15. The fire-extinguishing agent spray device as claimed in claim 14, wherein the siphon tube comprises a hollow tube.

16. The fire-extinguishing agent spray device as claimed in claim 15, wherein the reference line is based on an inner bottom point of the container bottom surface.

17. The fire-extinguishing agent spray device as claimed in claim 16, wherein the reference line is a horizontal line passing through the inner bottom point of the container bottom surface.

18. The fire-extinguishing agent spray device as claimed in claim 17, wherein the inclination angle of the lower end of the siphon tube is about 0 degrees or more.

19. The fire-extinguishing agent spray device as claimed in claim 18, wherein a distance (h) from the lower end of the siphon tube to the inner bottom point of the container bottom surface is calculated as follows:
$$h = \frac{π {t}_{t}^{2}}{2 π {r}_{t}} + p$$
wherein rₜ represents an inner radius of the siphon tube, and wherein ρ represents a pitch of a thread for assembling the siphon tube to the discharge valve.

20. The fire-extinguishing agent spray device as claimed in claim 19, wherein the distance from the lower end of the siphon tube to the inner bottom point of the container bottom surface is about three times the pitch of the thread.

21. The fire-extinguishing agent spray device as claimed in claim 12, further comprising a support part for supporting a lower end of the spray container.
